(19) United States
(12) Patent Application Publication
(10) Pub. No.: US 2018/0191118 A1
(43) Pub. Date: Jul. 5, 2018

(54) DRONE WITH CRIMPING DEVICE AND METHOD OF OPERATION

(71) Applicant: Hubbell Incorporated, Shelton, CT (US)

(72) Inventor: Lee Herron, Fairhope, AL (US)

(21) Appl. No.: 15/857,816

(22) Filed: Dec. 29, 2017

Related U.S. Application Data
(60) Provisional application No. 62/440,174, filed on Dec. 29, 2016.

(51) Int. Cl. H01R 43/048; B64C 39/02; B64D 47/08; B64D 1/00; B64C 27/08; G05D 1/00

(52) U.S. Cl. CPC H01R 43/048; B64C 39/024; B64D 47/08; B64C 2201/027; B64C 27/08; G05D 1/0038; B64C 2201/146; B64D 1/00

(57) ABSTRACT

A drone for performing a remote operation on a utility line includes a body member and a first rotor arm extending from the body member. A first rotor is attached to the rotor arm. A first mount extends from the body member and a camera is connected to the first mount. A second mount extends from the body member and a positioning arm is connected to the second mount. A third mount extends from the body member and a crimping device is connected to the third mount.

### FIELD

Various exemplary embodiments relate to an apparatus and method for utilizing a drone in utility transmission line repair.

### BACKGROUND

Utility transmission lines, for example power lines, are typically strung along long distances and supported at intermediate lengths by poles or towers. Transmission line repair typically involves the use of bucket trucks with long extensions to allow a technician to reach the cables or conductors. Repair operations often must be performed while a transmission line is operable, for example a live power conductor, which is hazardous to the technician.

### SUMMARY

According to an exemplary embodiment, a drone for performing a remote operation on a utility line includes a body member and a first rotor arm extending from the body member. A first rotor is attached to the rotor arm. A first mount extends from the body member and a camera is connected to the first mount. A second mount extends from the body member and a positioning arm is connected to the second mount. A third mount extends from the body member and a crimping device is connected to the third mount.

Another exemplary embodiment includes a method of connecting or repairing an electrical connector to an electrical conductor. A drone is maneuvered to a utility line electrical conductor. An electrical component is placed on the conductor using a positioning arm attached to the drone. An installation or repair device carried by the drone engages the electrical component. The electrical component is secured to the conductor.

### BRIEF DESCRIPTION OF THE DRAWINGS

The aspects and features of various exemplary embodiments will be more apparent from the description of those exemplary embodiments taken with reference to the accompanying drawings, in which:

FIG. 1 is a perspective view of an exemplary drone crimper and utility line.

### DETAILED DESCRIPTION OF EXEMPLARY EMBODIMENTS

Drone usage is increasing as the technology for these remotely controlled vehicles develops to allow for a broader range of applications, such as home delivery services. Various exemplary embodiments described herein are directed to an apparatus and methods for utilizing a drone to perform repair or installation operations associated with utility transmission lines.

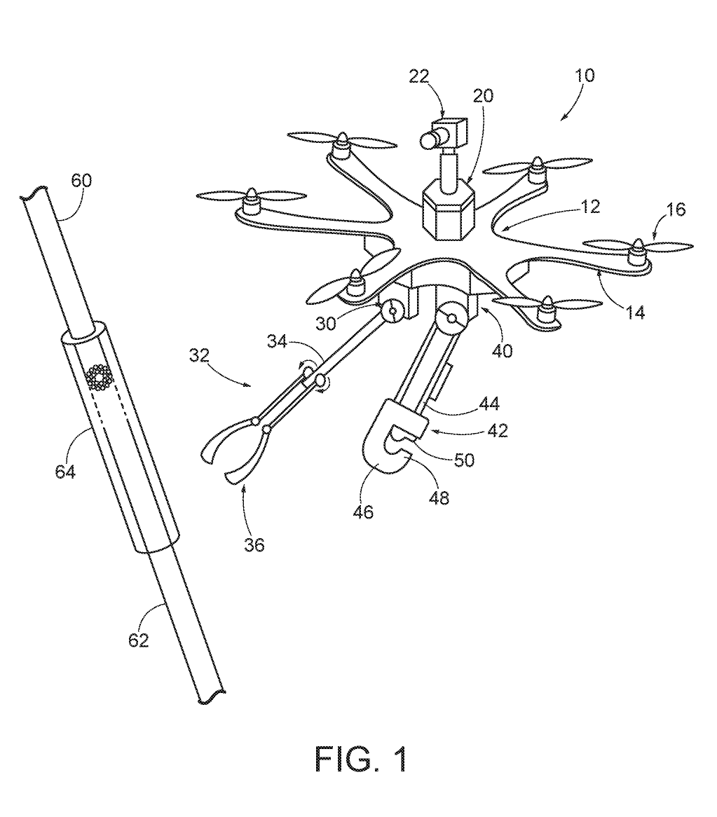

FIG. 1 shows an exemplary embodiment of a drone 10, depicted as a multi-rotor helicopter style drone. The drone 10 includes a body 12, rotor arms 14 extending from the body 12, and a rotor 16 positioned at the end of each rotor arm 14. This embodiment depicts six rotors, although fewer or more rotors can be used.

Various mounts extend from the body that can be used to incorporate peripheral devices. The exemplary embodiment shows three mounts and peripheral devices, although fewer or more mounts and peripheral devices can be incorporated into the drone depending on the desired operations.

The first mount 20 is used to connect a camera 22 or other image/video capture device. The first mount 20 can be configured to allow for movement along and rotation about different axes. For example a telescopic multi-axis gimbal mount can be used as illustrated to allow the position of the camera 22 from the base to be altered, and to allow for rotation and pivoting of the camera 22 around one to three axes. Movement of the camera 22 can be controlled by a drive device, for example one or more servo or brushless motors.

The second mount 30 is used to connect a positioning arm 32 to the body 12. The positioning arm 32 has a telescopic shaft 34 and a gripping head 36. In an exemplary embodiment, at least the griping head 36 of the positioning arm 32 is made from a non-conductive material. The second mount 30 can be configured to allow for rotation and pivoting of the positioning arm 32 around one to three axes. For example a multi-axis gimbal mount can be used. Movement of the positioning arm 32 can be controlled by a drive device, for example one or more servo or brushless motors. Although only a single positioning arm 32 is shown, multiple arms can be used to perform different operations, such as holding and positioning one or more cables and holding and positioning a crimping sleeve.

The third mount 40 is used to moveably connect an installation or repair device to the body 12. In the exemplary embodiment shown the device is a crimping device 42. The third mount 40 can be configured to allow for movement along and rotation about different axes. For example a telescopic, multi-axis gimbal mount can be used to allow the position of the crimping device 42 from the base to be altered, and to allow for rotation and pivoting of the crimping device 42 around one to three axes. Movement of the crimping device 42 can be controlled by a drive device, for example one or more servo or brushless motors.

In an exemplary embodiment the crimping device 42 is a battery operated crimping device having an arm 44 and a crimping head 46. The arm 44 includes an integral mounting portion to connect to the third mount 40 on the drone 10. In some embodiments, the arm 44 is also telescopic. The crimping head 46 has a first, stationary jaw 48 and a second, moveable jaw 50 that is connected to a ram. The ram can be driven by an electric motor through a set of gears or by a hydraulic fluid that is moved via a pump driven by the electric motor. The jaws 48, 50 can be a standard size or can utilize interchangeable dies that are removed or attached to the jaws as needed. The different sizes, shapes, and configurations of crimping dies that can be used would be understood by one of ordinary skill in the art.

The drone 10 can include various control and communication components for transmitting and receiving data. The drone 10 can contain a radio-control communication unit that can receive signals from a user and transmit data to the user. The drone 10 can be configured to send data to a user, including camera images, force feedback, and other sensor data. The communication unit can be operatively connected to a control unit that interprets the signals from the communication unit to operate the rotors 16 and the positioning and control of the periphery devices. The drone 10 can also contain one or more movement and/or orientation sensors, for example gyroscopes, that enable automatic hover and stabilization of the drone 10. Because a number of the peripheral devices are intended to extend outside of the rotor envelope of the drone, auto stabilization can help maintain orientation and position while operations are performed.

Although described with regard to the crimping tool, the present disclosure is also applicable to other tools utility lines tools, such as cutting tools, hot sticks, oxide removing brushes, clamps, and pullers.

In an exemplary operation, the drone 10 and the peripheral devices operate together to provide remote connector installation on an overhead utility transmission line. The drone 10 is positioned at or near a first cable 60 that is to be connected to a second cable 62 by a sleeve 64. The sleeve 64 can be, for example, a U-shaped conductive material. The first or second cable 60, 62 can be held in place by another device, such as a hot-stick pole or another drone. Using one or more positioning arms 32, the drone positions the first and second conductors 60, 62 into the sleeve 64. The crimping device 42 is then engaged to crimp the sleeve 64 in one or more places to secure the conductors 60, 62.

The camera 22 provides feedback to a user to allow for proper positioning and quality control inspection. In an exemplary embodiment, the camera 22 includes a proximity sensor system that can lock onto the connector/accessory after the operator moves to a close range, and the drone position can be maintained with electronic feedback control.

In an alternative operation, the crimping tool and positioning arms would allow the operator to shut down the drone drive train and use the tool and arm like “crab legs” and move along the connector to make crimps. This will save the drone battery charge for more operations per flight.

Although described with regard to a crimping operation, the present disclosure is also applicable to other utility line installation and repair operations. For example the drone can be configured to utilize peripheral devices to install mesh wrap type repair sleeves that can be installed over high resistance splices.

In another embodiment, the drone can be configured to utilize a brush or other similar tool to move along a utility line and remove aluminum oxide from a conductor surface. A motorized wire-brush wheel can be attached to a line and the drone can be piloted along the line to perform this operation.

In another embodiment, the drone can be configured to install lighting protection connector and accessories on utility structures or to install accessories such as span spacers and dampers along utility lines.

In another embodiment the drone can also be configured for use in installing safety grounding applications, utilizing a torque limited wrench to apply ground clamps to energized lines.

The foregoing detailed description of the certain exemplary embodiments has been provided for the purpose of explaining the general principles and practical application, thereby enabling others skilled in the art to understand the disclosure for various embodiments and with various modifications as are suited to the particular use contemplated. This description is not necessarily intended to be exhaustive or to limit the disclosure to the exemplary embodiments disclosed. Any of the embodiments and/or elements disclosed herein may be combined with one another to form various additional embodiments not specifically disclosed. Accordingly, additional embodiments are possible and are intended to be encompassed within this specification and the scope of the appended claims. The specification describes specific examples to accomplish a more general goal that may be accomplished in another way.

As used in this application, the terms “front,” “rear,” “upper,” “lower,” “upwardly,” “downwardly,” and other orientational descriptors are intended to facilitate the description of the exemplary embodiments of the present disclosure, and are not intended to limit the structure of the exemplary embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments.

What is claimed:

1. A drone for performing a remote operation on a utility line comprising:
a body member;
a first rotor arm extending from the body member;
a first rotor attached to the rotor arm;
a first mount extending from the body member;
a camera connected to the first mount;
a second mount extending from the body member;
a positioning arm connected to the second mount;
a third mount extending from the body member; and
a crimping device connected to the third mount.

2. The drone of claim 1, wherein the first mount is a telescopic gimbal mount.

3. The drone of claim 1, wherein the positioning arm includes a telescopic shaft and a gripper head.

4. The drone of claim 1, wherein the crimping device includes an arm and a crimping head.

5. The drone of claim 4, wherein the crimping head includes a first jaw and a second jaw.

6. The drone of claim 5, wherein the crimping the first and second jaws are removably connected to the crimping head.

7. The drone of claim 1, further comprising a second rotor arm connected to the body member and a second rotor connected to the second rotor arm.

8. The drone of claim 1, wherein the second and third mounts are multi-axis gimbal mounts.

9. A method of connecting or repairing an electrical connector to an electrical conductor comprising:
maneuvering a drone to a utility line electrical conductor;
placing an electrical component on the conductor using a positioning arm attached to the drone;
engaging an installation or repair device carried by the drone with the electrical component; and
securing the electrical component to the conductor.

10. The method of claim 9, wherein the electrical component includes an electrical connector and securing the electrical component includes crimping the electrical connector.

11. The method of claim 10, wherein the electrical connector is a connector sleeve.

12. The method of claim 9, further comprising capturing an image or the electrical connector and transmitting the image to an operator.

13. The method of claim 12, wherein the image is captured using a camera connected to the drone.

14. The method of claim 13, wherein the camera is movably mounted on the drone.

15. The method of claim 9, wherein the electrical component is one of a grounding connector, line spacer, or line damper.

16. The method of claim 9, wherein the positioning arm includes a telescopic shaft and a gripper head.

17. The method of claim 9, wherein the positioning arm is connected to the drone by a gimbal mount.

18. The method of claim 9, wherein the installation or repair device includes a crimping device.

19. The method of claim 18, wherein the crimping device includes an arm and a crimping head.

20. The method of claim 18, wherein the crimping device is connected to the drone by a gimbal mount.
